(19) United States
(12) Patent Application Publication
(10) Pub. No.: US 2025/0319854 A1
(43) Pub. Date: Oct. 16, 2025

(54) CONTROL DEVICE AND METHOD FOR OPERATING A BRAKING SYSTEM BELONGING TO A VEHICLE AND EQUIPPED WITH A BRAKE-ACTUATION HYDRAULIC UNIT AND AN ESC HYDRAULIC UNIT

(71) Applicant: Robert Bosch GmbH, Stuttgart (DE)

(72) Inventors: Daniel Diegel, Stuttgart (DE); Samuel Bubeck, Yokohama-Shi (JP)

(21) Appl. No.: 18/849,866

(22) PCT Filed: Apr. 26, 2023
(86) PCT No.: PCT/EP2023/060934

§ 371 Date: Sep. 23, 2024

(30) Foreign Application Priority Data
May 6, 2022 (DE) 10 2022 204 485.1

(51) Int. Cl. B60T 13/66; B60T 13/14; B60T 13/68; B60T 13/74; B60T 17/22

(52) U.S. Cl. CPC B60T 13/662; B60T 13/146; B60T 13/686; B60T 13/745; B60T 17/22; B60T 2270/308

(57) ABSTRACT

A control device and method for a braking system. The method includes reading out or checking, based on at least one signal, whether a predefined error state exists at a brake-actuation hydraulic unit, which is mounted on an ESC hydraulic unit, and performing at least one of the following steps if it is determined that the at least one predefined error state exists at the brake-actuation hydraulic unit: activating at least one pump of the ESC hydraulic unit in order to draw in a firmly predefined or specified brake fluid volume from a brake fluid reservoir of the braking system, and/or controlling at least one electric motor of the vehicle which can be operated in a regenerative mode, to effect a firmly predefined or specified motor braking torque not equal to zero at at least one wheel of the vehicle and/or at least one axle of the vehicle.

### FIELD

The present invention relates to a control device for a braking system belonging to a vehicle and equipped with a brake-actuation hydraulic unit and an ESC hydraulic unit. The present invention also relates to an ESC hydraulic unit for a braking system belonging to a vehicle and additionally equipped with a brake-actuation hydraulic unit and to a braking system for a vehicle. Furthermore, the present invention relates to a method for operating a braking system belonging to a vehicle and equipped with a brake-actuation hydraulic unit and an ESC hydraulic unit.

### BACKGROUND INFORMATION

FIG. 1 shows a conventional braking system which is known to the applicant as internal related art.

The conventional braking system shown schematically in FIG. 1 has a hydraulic system 10 into which a master brake cylinder 12 and an ESC system 14 are integrated. For each wheel 16 of a vehicle equipped with the conventional braking system, a wheel brake cylinder 18 is connected to the hydraulic system 10. In addition, a brake fluid reservoir 20, an electromechanical brake booster 22 and a brake pedal 24 are connected to the master brake cylinder 12. The electromechanical brake booster 22 is intended to be usable in particular as an actuator/controller for effecting driver-assisting or autonomous brake pressure increases in the wheel brake cylinders 18. The ESC system 14, which can be controlled by means of its control unit 26, refers to components of the conventional braking system that are configured to perform ABS and/or ESC functions.

### SUMMARY

The present invention provides a control device for a braking system belonging to a vehicle and equipped with a brake-actuation hydraulic unit and an ESC hydraulic unit, an ESC hydraulic unit for a braking system belonging to a vehicle and additionally equipped with a brake-actuation hydraulic unit, a braking system for a vehicle, and a method for operating a braking system belonging to a vehicle and equipped with a brake-actuation hydraulic unit and an ESC hydraulic unit.

The present invention provides possibilities for improved use of a braking system formed with an ESC hydraulic unit and a brake-actuation hydraulic unit, thereby facilitating its introduction. As will become clear from the following description, the present invention makes particular advantages possible for the braking system designed with the ESC hydraulic unit and with the brake-actuation hydraulic unit compared to a conventional braking system having only a single hydraulic unit. The present invention provides, especially in the event of a functional impairment or failure of the brake-actuation hydraulic unit, a use of the ESC hydraulic unit and/or the at least one electric motor of the vehicle equipped with the particular braking system for performing autonomous braking and providing force support to the driver of the vehicle during driver-induced braking. Thus, in these situations where a conventional braking system often has only its mechanical fallback level usable for braking the vehicle, the present invention can still provide good braking comfort for the driver.

According to an example embodiment of the present invention, preferably, if the control device determines, in light of the at least one signal, that the single predefined error state or at least one of the predefined error states exists at the brake-actuation hydraulic unit, the control device is configured and/or programmed to determine a target volume of the brake fluid volume to be drawn in from the brake fluid reservoir in light of at least one sensor signal of at least one brake-actuation element sensor of the braking system and/or at least one pressure sensor of the ESC hydraulic unit and/or the brake-actuation hydraulic unit, and then activate the at least one pump of the ESC hydraulic unit in order to draw in the brake fluid volume corresponding to the specified target volume from the brake fluid reservoir. The braking effected in this way can thus be adapted to the current braking requirement.

Alternatively or additionally, according to an example embodiment of the present invention, if the control device determines, in light of the at least one signal, that the single predefined error state or at least one of the predefined error states exists at the brake-actuation hydraulic unit, the control device can also be configured and/or programmed to determine a target braking torque of the motor braking torque to be exerted at the at least one wheel and/or at the at least one axle in light of the at least one sensor signal of the at least one brake-actuation element sensor of the braking system and/or the at least one pressure sensor of the ESC hydraulic unit and/or the brake-actuation hydraulic unit, and then actuate the at least one electric motor in order to effect the motor braking torque corresponding to the specified target braking torque at the at least one wheel and/or at the at least one axle. The operation of the at least one electric motor can thus also be adapted to the current braking request.

In an advantageous embodiment of the present invention, the control device is configured and/or programmed to detect a functional impairment and/or a failure of a brake booster of the brake-actuation hydraulic unit, a functional impairment and/or a failure of at least one valve of the brake-actuation hydraulic unit, a functional impairment and/or a failure of at least one sensor apparatus of the brake-actuation hydraulic unit and/or a functional impairment and/or a failure of a first power supply of at least the brake booster of the brake-actuation hydraulic unit, the at least one valve of the brake-actuation hydraulic unit and/or the at least one sensor apparatus of the brake-actuation hydraulic unit as the at least one predefined error state on the basis of the at least one signal. The embodiment of the control device described here can therefore activate/control the ESC hydraulic unit and/or the at least one regeneratively operable electric motor to provide force support for driver-induced braking and/or to perform/continue autonomous braking in the event of a plurality of error states of the brake-actuation hydraulic unit. Error states in which conventionally only the mechanical fallback level is still usable can therefore be advantageously bridged at least temporarily with the embodiment of the control device described here.

Preferably, according to an example embodiment of the present invention, the control device, at least as long as the at least one predefined error state does not exist at the brake-actuation hydraulic unit, is configured and/or programmed to detect a wheel lock effected by means of at least one of the wheel brake cylinders on the basis of at least one measurement signal from at least one speed sensor of at least one wheel of the vehicle and optionally switch at least one valve of the ESC hydraulic unit to its open state such that brake fluid can be drained from the at least one blocking wheel brake cylinder via the at least one open valve. The embodiment of the control device described here can thus also cause wheel locks to be eliminated in addition to its advantageous properties explained above.

An ESC hydraulic unit for a braking system belonging to a vehicle and additionally equipped at least with a brake-actuation hydraulic unit, comprising such a control device also provides the advantages described above.

For example, according to the present invention, the ESC hydraulic unit can comprise at least one high-pressure switching valve, via which a corresponding intake side of the at least one pump of the ESC hydraulic unit is hydraulically connectable or connected to the brake fluid reservoir of the braking system, wherein the control device is additionally configured and/or programmed to switch the at least one high-pressure switching valve to its open state while operation of the at least one pump is activated in order to draw in the brake fluid volume from the brake fluid reservoir. This provides rapid transfer of the brake fluid volume from the brake fluid reservoir, in particular into the ESC hydraulic unit.

The advantages explained above are also provided in a braking system for a vehicle, comprising a corresponding ESC hydraulic unit, the brake-actuation hydraulic unit mounted on the ESC hydraulic unit and the wheel brake cylinders mounted on the ESC hydraulic unit.

In an advantageous embodiment of the braking system of the present invention, the brake-actuation hydraulic unit is connectable or connected to the first power supply and the ESC hydraulic unit is connectable or connected to a second power supply. Thus, even if the first power supply fails and the functionality of the brake-actuation hydraulic unit is significantly limited, the ESC hydraulic unit can still be used to perform/continue autonomous braking and/or to provide force support for driver-induced braking.

According to an example embodiment of the present invention, preferably, the brake-actuation hydraulic unit has control electronics which are configured and/or programmed to control at least the brake booster of the brake-actuation hydraulic unit in light of at least the brake-actuation element sensor of the braking system and/or the at least one pressure sensor of the brake-actuation hydraulic unit. This means that during normal operation of the braking system, in which no fault state exists at the brake-actuation hydraulic unit, the control electronics can be used to relieve the advantageous control device of the braking system.

In a further advantageous embodiment of the braking system of the present invention, the brake booster of the brake-actuation hydraulic unit is a brake booster arranged upstream of a master brake cylinder of the brake-actuation hydraulic unit or a motorized piston-cylinder device integrated into the hydraulic system of the brake-actuation hydraulic unit. In both cases, the brake booster can be used to perform autonomous braking and/or to provide force support for driver-induced braking during normal operation of the braking system equipped therewith, provided there is no error state at the brake-actuation hydraulic unit, while the inability of the brake booster to be used for these purposes can be advantageously bridged at least temporarily by means of the ESC hydraulic unit.

Furthermore, performing a corresponding method for operating a braking system belonging to a vehicle and equipped with a brake-actuation hydraulic unit and an ESC hydraulic unit also provides the advantages explained above. It is expressly noted that the method can be further formed in accordance with the embodiments of the control device, the ESC hydraulic unit and/or the braking system described above.

### BRIEF DESCRIPTION OF THE DRAWINGS

Further features and advantages of the present invention will be explained in the following with reference to the figures.

FIG. 1 shows a conventional braking system.

FIG. 2 shows a schematic representation of a braking system equipped with a brake-actuation hydraulic unit and an ESC hydraulic unit for explaining an example embodiment of the control device, according to the present invention.

FIG. 3A to 3C shows a flowchart and coordinate systems for explaining an example embodiment of the method for operating a braking system belonging to a vehicle and equipped with a brake-actuation hydraulic unit and an ESC hydraulic unit, according to the present invention.

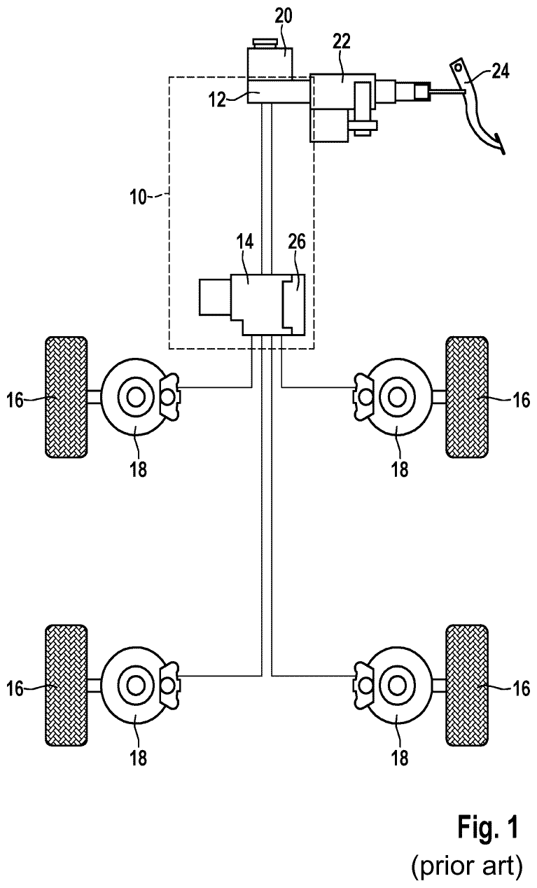

### DETAILED DESCRIPTION OF EXAMPLE EMBODIMENTS

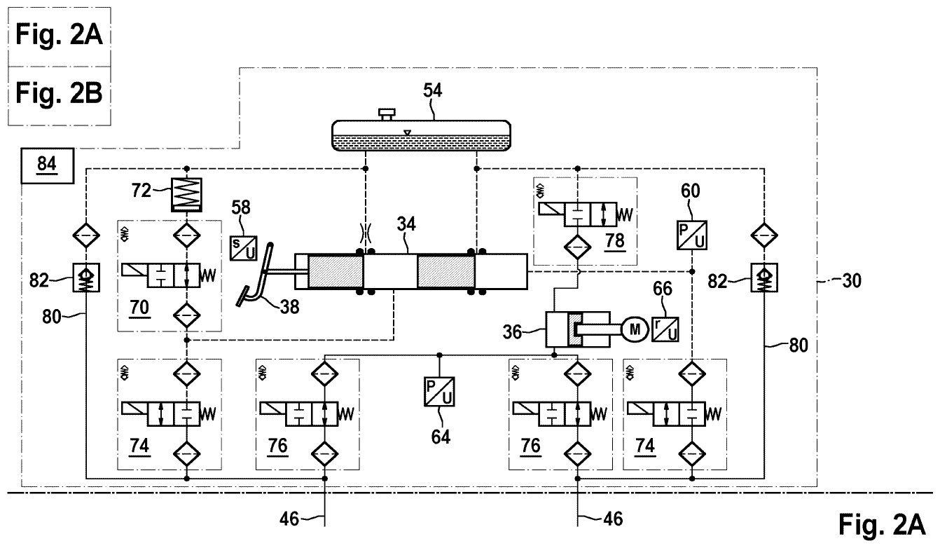

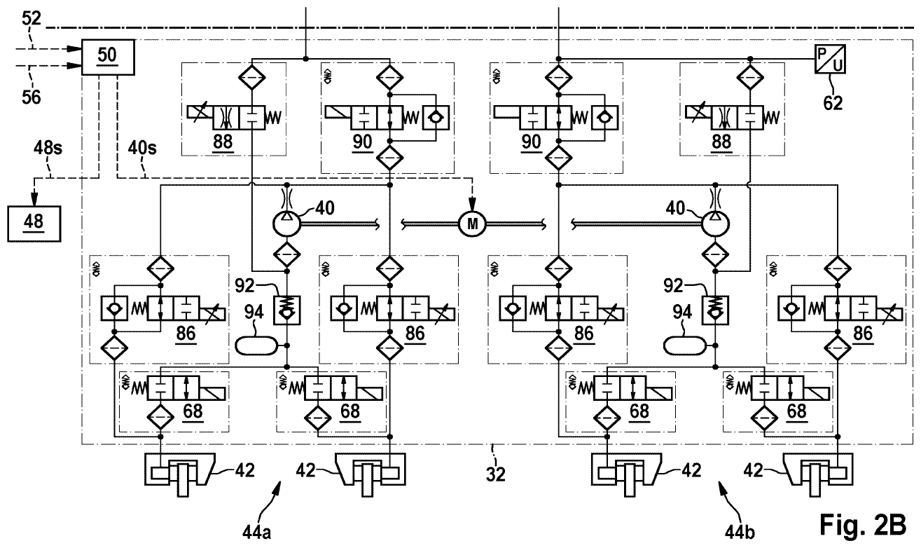

FIG. 2 is a schematic representation of a braking system equipped with a brake-actuation hydraulic unit and an ESC hydraulic unit to explain an embodiment of the control device.

The braking system shown schematically in FIG. 2 has a brake-actuation hydraulic unit 30 and an ESC hydraulic unit 32. The brake-actuation hydraulic unit 30 is to be understood as a unit which is produced separately from the ESC hydraulic unit 32 and which can also be referred to as a brake actuation hydraulic module 30 or as a brake actuation hydraulic sub-unit 30. The brake-actuation hydraulic unit 30 is equipped with at least one master brake cylinder 34 and with a brake booster 36, wherein the brake-actuation hydraulic unit 30 is connected to or mounted on the ESC hydraulic unit 32 only after its production. As will become clear from the following description, equipping the braking system with a brake-actuation element 38 connected to the master brake cylinder 34, such as a brake pedal 38, is optional due to the high safety standards of the braking system when performing autonomous braking.

The ESC hydraulic unit 32 is also to be understood as a unit which is produced separately from the brake-actuation hydraulic unit 30 and which can be described as an ESP hydraulic module 32 or as an ESP hydraulic sub-unit 32. Hydraulic components, such as in particular at least one pump 40, are integrated into the ESC hydraulic unit 32, by means of which ABS and/or ESC functions can be performed on the braking system of FIG. 2.

In addition to the brake-actuation hydraulic unit 30 and the ESC hydraulic unit 32, the braking system is also equipped with wheel brake cylinders 42, which are connected to/mounted on the ESC hydraulic unit 32. A total number of wheel brake cylinders 42 of the braking system can correspond to a total number of wheels of the vehicle equipped/to be equipped therewith. It should be noted that the usability of the braking system is not limited to any particular vehicle type/motor vehicle type of the vehicle/motor vehicle equipped with the braking system, or to a specific total number of wheels of the vehicle/motor vehicle.

The braking system of FIG. 2 has, by way of example only, two braking circuits 44a and 44b. In addition, the hydraulic units 30 and 32 are connected to one another, by way of example only, via one brake line 46 per braking circuit 44a and 44b. The hydraulic connection of the two hydraulic units 30 and 32 shown schematically in FIG. 2 is to be interpreted merely as an example.

FIG. 2 also shows a control device 50 which is configured and/or programmed to ascertain whether at least one predefined error state exists at the brake-actuation hydraulic unit 30. The possible presence of at least one predefined error state in the brake-actuation hydraulic unit 30 is ascertained by checking or reading out at least one signal 52 provided to the control device 50. (Examples of the at least one signal 52 read out and/or checked by the control device 50 are given below.)

If necessary, i.e. if the control device 50 determines, in light of the at least one signal 52, that the single predefined error state or at least one of the predefined error states exists at the brake-actuation hydraulic unit 30, the control device 50 is configured and/or programmed to perform at least one of the two actions explained below. For example, the control device 50 can be configured and/or programmed to activate, as a first action, at least the at least one pump 40 of the ESC hydraulic unit 32 by means of at least one first control signal 40s in order to draw in a brake fluid volume which is firmly predefined or is specified by the control device 50 from a brake fluid reservoir 54 of the braking system. Preferably, the brake fluid reservoir 54 from which the brake fluid volume additionally drawn into the braking circuits 44a and 44b is taken is a brake fluid reservoir 54 connected to the master brake cylinder 34, specifically via at least one compensating port.

By drawing in the additional brake fluid volume from the brake fluid reservoir 54 (action 1), the wheel brake cylinders 42 are additionally filled. The action 1 therefore makes force support of driver-induced braking possible despite a functional impairment or failure of the brake-actuation hydraulic unit 30. Driver-induced braking is understood to mean braking requested by the driver by means of the driver braking force (not equal to zero) exerted on the brake-actuation element 38. However, by means of the action 1, autonomous braking of the vehicle can also be performed or continued. Autonomous braking is also understood to mean braking requested by an automatic speed control system of the vehicle during which the driver does not actuate the brake-actuation element 38. The automatic speed control system can, for example, be an adaptive cruise control or an emergency braking system.

It is also pointed out here that the possibility of drawing in the additional brake fluid volume from the brake fluid reservoir 54 as required, implemented by means of the control device 50, often allows for reduced dimensioning of the master brake cylinder 34. The advantageous configuration/programming of the control device 50 thus facilitates miniaturization of the braking system of FIG. 2.

Alternatively or additionally, the control device 50 can also be configured and/or programmed to control, as a second action, at least one electric motor 48 of the vehicle equipped with the braking system by means of at least one second control signal 48s in order to effect a motor braking torque which is not equal to zero and is firmly predefined or is specified by the control device 50 at at least one wheel of the vehicle and/or at at least one axle of the vehicle. The at least one electric motor 48 is understood to be a motor which can be operated in its regenerative mode such that the vehicle can be/is braked by means of the motor braking torque applied to the at least one wheel and/or to the at least one axle. The at least one electric motor 48 can in particular be a drive motor of the vehicle which can be operated in a regenerative mode.

The action 2 thus allows the at least one electric motor 48 to be used to brake the vehicle even if there is a functional impairment or failure of the brake-actuation hydraulic unit 30. By controlling the at least one electric motor 48 according to the action 2, the driver can be supported in terms of force during driver-induced braking by braking the vehicle with the motor braking torque of the at least one electric motor 48 in addition to the friction braking torque exerted by the wheel brake cylinders 42. Furthermore, by means of the action 2, the at least one electric motor 48 can also be used to continue or perform autonomous braking by means of its motor braking torque exerted on the at least one wheel and/or the at least one axle of the vehicle, even in the event of a functional impairment or failure of the brake-actuation hydraulic unit 30.

The advantageous configuration/programming of the control device 50 thus provides advantageous possibilities for force support of driver-induced braking and/or for continuing or performing autonomous braking despite a functional impairment or failure of the brake-actuation hydraulic unit 30. The advantageous configuration/programming of the control device 50 therefore results in an extension of conventional emergency functions, in particular for the force support of driver-induced braking and/or for continuing or performing autonomous braking, even in the event of a complete failure of a brake booster 36 otherwise used for this purpose. While in a conventional braking system, if its brake booster fails completely, it is generally no longer possible to provide force support for driver-induced braking and autonomous braking must be aborted immediately; these disadvantages are remedied by using the control device 50 for the type of braking system described here. It is also pointed out here that even if the function of the brake-actuation hydraulic unit 30 is significantly impaired, the braking system of FIG. 2 does not yet have to be operated at its mechanical fallback level because the possibilities explained above for force-support of driver-induced braking and/or for continuing or performing autonomous braking can still be used by means of the control device 50 and the ESC hydraulic unit 32.

The braking system of FIG. 2 equipped with the control device 50 thus has, above all, an advantageously high safety standard when performing autonomous braking. It is therefore possible to dispense with equipping the braking system with its brake-actuation element 38.

Preferably, if the control device 50 determines, in light of the at least one signal 52, that the single predefined error state or at least one of the predefined error states exists at the brake-actuation hydraulic unit 30, the control device 50 is configured and/or programmed to specify a target volume of the brake fluid volume to be drawn in from the brake fluid reservoir 54. The target volume can be determined according to a braking request indicated by the driver by means of his actuation of the brake-actuation element 38 in that the target volume can be set in light of at least one sensor signal 56 of at least one brake-actuation element sensor 58 of the braking system and/or at least one pressure sensor 60 and 62 of the ESC hydraulic unit 30 and/or the brake-actuation hydraulic unit 32. The control device 50 can then activate/control at least one pump 40 of the ESC hydraulic unit 32 in order to draw in the brake fluid volume corresponding to the specified target volume from the brake fluid reservoir 54. Due to the consideration of at least one sensor signal 56 for specifying the target volume in the case of driver-induced braking, the force support provided is a metered amplification of the driver-induced braking in accordance with the braking request of the driver. Accordingly, even in the case of autonomous braking, the braking request of the cruise control system can be reliably met in light of the at least one sensor signal 56 for specifying the target volume. Due to the procedure described here when drawing in the brake fluid volume from the brake fluid reservoir 54, the brake pressure in the wheel brake cylinders 42 always increases in accordance with the braking request of the driver or the cruise control system, which is why the driver does not find or hardly finds a brief reaction to the brake-actuation element 38 disturbing.

Likewise, if the control device 50 determines, in light of the at least one signal 52, that the single predefined error state or at least one of the predefined error states exists at the brake-actuation hydraulic unit 30, the control device can be configured and/or programmed to specify a target braking torque of the engine braking torque to be exerted on the at least one wheel and/or the at least one axle. The at least one sensor signal 56 of the at least one brake-actuation element sensor 58 and/or the at least one pressure sensor 60 and 62 can also be evaluated to specify the target braking torque. Optionally, the control device 50 then controls the at least one electric motor 48 in order to effect the motor braking torque corresponding to the specified target braking torque at the at least one wheel and/or the at least one axle. In the manner described here, the motor braking torque produced can correspond to a braking request by actuating the brake-actuation element 38 or by the automatic speed control system both when force-supporting driver-induced braking and when continuing or performing autonomous braking, so that good braking and driving comfort is ensured despite the functional impairment or failure of the brake-actuation hydraulic unit 30.

The at least one brake-actuation element sensor 58 can, for example, be a rod travel sensor and/or a differential travel sensor. The at least one pressure sensor 60 and 62 can be a pressure sensor 60 of the brake-actuation hydraulic unit 30 connected to the master brake cylinder 34 and/or a pressure sensor 62 of the ESC hydraulic unit 32. Preferably, the control device 50 is configured/programmed to prioritize evaluating the at least one sensor signal 56 of the at least one brake-actuation element sensor 58 and/or of the pressure sensor 60 of the brake-actuation hydraulic unit 30 connected to the master brake cylinder 34 in order to provide force-supported driver-induced braking and/or to continue or perform autonomous braking, and to (co-)evaluate the sensor signal 56 of the pressure sensor 62 of the ESC hydraulic unit 32 only if there is a high probability of at least one functional impairment existing at the at least one brake-actuation element sensor 58 and/or the pressure sensor 60 of the brake-actuation hydraulic unit 30 connected to the master brake cylinder 34.

The at least one predefined error state, which can be identified on the basis of the at least one signal 52 from the control device 50, can include, for example, a functional impairment and/or a failure of the brake booster 36 of the brake-actuation hydraulic unit 30. The functional impairment or failure of the brake booster 36 can be detected, for example, by evaluating or comparing at least one signal 52 of the at least one brake-actuation element sensor 58 and/or the pressure sensor 60 of the brake-actuation hydraulic unit 30 connected to the master brake cylinder 34 to the at least one signal 52 of the pressure sensor 62 of the ESC hydraulic unit 32 and/or a pressure sensor 64 of the brake-actuation hydraulic unit 30 connected to the brake booster 36. To examine/check the brake booster 36, at least one signal 52 of a motor current sensor of the brake booster 36 and/or of a rotation angle sensor 66 of the brake booster 36 can also be (co-)evaluated. A functional impairment and/or a failure of at least one valve of the brake-actuation hydraulic unit 30 can also be detected as a predefined error state by evaluating or comparing the at least one signal 52 of the at least one brake-actuation element sensor 58, the at least one pressure sensor 60, 62 and 64 of the brake-actuation hydraulic unit 30 and/or the ESC hydraulic unit 32, the motor current sensor and/or the rotation angle sensor 66. A functional impairment and/or a failure of at least one sensor apparatus of the brake-actuation hydraulic unit 30, such as at least one of its pressure sensors 60 and 64, can accordingly also be detected as a predefined error state by means of evaluating or comparing the at least one signal 52 of the at least one brake-actuation element sensor 58, the at least one pressure sensor 60, 62 and 64 of the brake-actuation hydraulic unit 30 and/or the ESC hydraulic unit 32, the motor current sensor and/or the rotation angle sensor 66. Furthermore, on the basis of at least one signal 52 of a current sensor (not shown) of a first power supply, to which at least the brake booster 36, the at least one valve of the brake-actuation hydraulic unit 30 and/or the at least one sensor apparatus of the brake-actuation hydraulic unit 30 are electrically connected, it can be determined as a predefined error state that the first power supply is impaired in its function or has failed. Thus, a plurality of different error states of the brake-actuation hydraulic unit 30 can be reliably detected by means of the sensors already conventionally used on a vehicle.

The control device 50 can in particular be a control device 50 of the ESC hydraulic unit 32. Preferably, at least as long as the single predefined error state or at least one of the predefined error states does not exist at the brake-actuation hydraulic unit 30, the control device 50 is configured and/or programmed to detect a wheel lock and, if necessary, to eliminate it. A possible wheel lock can be detected on the basis of at least one measurement signal from at least one speed sensor (not shown) of at least one wheel of the vehicle. In this way it can be reliably determined whether one of the wheels of the vehicle is blocked by at least one of the wheel brake cylinders 42. If a wheel lock is detected, at least one wheel outlet valve 68 of the ESC hydraulic unit 32 can be switched to its open state by the control device 50 in such a way that brake fluid is drained from the at least one blocked wheel brake cylinder 42 via the at least one open wheel outlet valve 68. The control device 50 can thus also be used to control/activate the “classic” ABS and/or ESC functions of the ESC hydraulic unit 32. Optionally, the control device 50 can also be configured/programmed to control/activate further assisted or semi-assisted functions.

In the braking system of FIG. 2, the brake booster 36 of the brake-actuation hydraulic unit 30 is, for example, a motorized piston-cylinder device 36 integrated into the hydraulic system of the brake-actuation hydraulic unit 30. The motorized piston-cylinder device 36 can also be referred to as a plunger device 36 or as an electric brake booster 36 decoupled from the master brake cylinder 34. The brake-actuation hydraulic unit 30 equipped with the motorized piston-cylinder device 36 can therefore also be described as a DPB hydraulic unit 30 (decoupled power brake). Alternatively, the brake booster 36 of the brake-actuation hydraulic unit 30 can also be a brake booster upstream of the master brake cylinder 34 of the brake-actuation hydraulic unit 30, such as specifically an electromechanical brake booster (iBooster).

As long as the single predefined error state or at least one of the predefined error states does not exist in the brake-actuation hydraulic unit 30, the driver can be prevented from braking into the wheel brake cylinders 42 by controlling and maintaining a simulator isolation valve 70, via which a simulator 72 is connected to the master brake cylinder 34, in its open state. While the driver brakes into the simulator 72 by actuating the brake-actuation element 38 via the open simulator isolation valve 70, the driver-induced braking can optionally be effected either by means of the motorized piston-cylinder device 36, by means of the at least one electric motor 48 of the vehicle operable in its regenerative mode, or by means of the motorized piston-cylinder device 36 and the at least one electric motor 48. With all the possibilities described here for effecting driver-induced braking, the driver braking into the simulator 72 always has a standard brake actuation/pedal feel.

The brake-actuation hydraulic unit 30 can optionally also have, for each braking circuit 44a and 44b, a first isolating valve 74, via which the assigned braking circuit 44a or 44b is connected to the master brake cylinder 34, and a second isolating valve 76, via which the assigned braking circuit 44a or 44b is connected to the motorized piston-cylinder device 36 used as a brake booster 36. Optionally, the motorized piston-cylinder device 36 can be connected to the brake fluid reservoir 54 via a further isolating valve 78 of the brake-actuation hydraulic unit 30. In addition, at least one suction line 80 having a pressure relief valve 82 can be formed in the brake-actuation hydraulic unit 30, via which the brake lines 46 are connected to the brake fluid reservoir 54. Optionally, the brake-actuation hydraulic unit 30 can also have (its own) control electronics 84 which are configured and/or programmed to control at least the brake booster 36 of the brake-actuation hydraulic unit 30 in light of at least the brake-actuation element sensor 58 of the braking system and/or the at least one pressure sensor 60 and 64 of the brake-actuation hydraulic unit 30. The control electronics 84 can thus relieve the control device 50 of work. Preferably, the control device 50 and the control electronics 84 are configured/programmed to communicate with each other, e.g. via bus communication.

In addition to its at least one wheel outlet valve 68, the ESC hydraulic unit 32 can also comprise at least one wheel inlet valve 86. Alternatively or additionally, the ESC hydraulic unit 30 can also have at least one high-pressure switching valve 88 and/or at least one changeover valve 90. If a particular intake side of the at least one pump 40 of the ESC hydraulic unit 32 is hydraulically connectable/connected to the brake fluid reservoir 54 of the braking system via the at least one high-pressure switching valve 88, the control device 50 can additionally be configured and/or programmed to switch the at least one high-pressure switching valve 88 to its open state during the activated operation of the at least one pump 40 in order to draw in the additional brake fluid volume from the brake fluid reservoir 54. In addition, at least one storage chamber 94 of the ESC hydraulic unit 32 can be connected to the relevant intake side of the at least one pump 40 via a pressure relief valve 92. While the brake-actuation hydraulic unit 30 can be connected/is connected to the first power supply, a connection to a second power supply is preferred for the ESC hydraulic unit 32. Even in the event of a complete failure of the first power supply, the control device 50 and the ESC hydraulic unit 32 can still perform their advantageous bridging functions explained above.

Use of the control device 50 provides a significantly higher degree of freedom in the hydraulic design of the braking system equipped/cooperating therewith. In particular, this can ensure that a specific type of braking system can be used for a plurality of vehicle types/motor vehicle types.

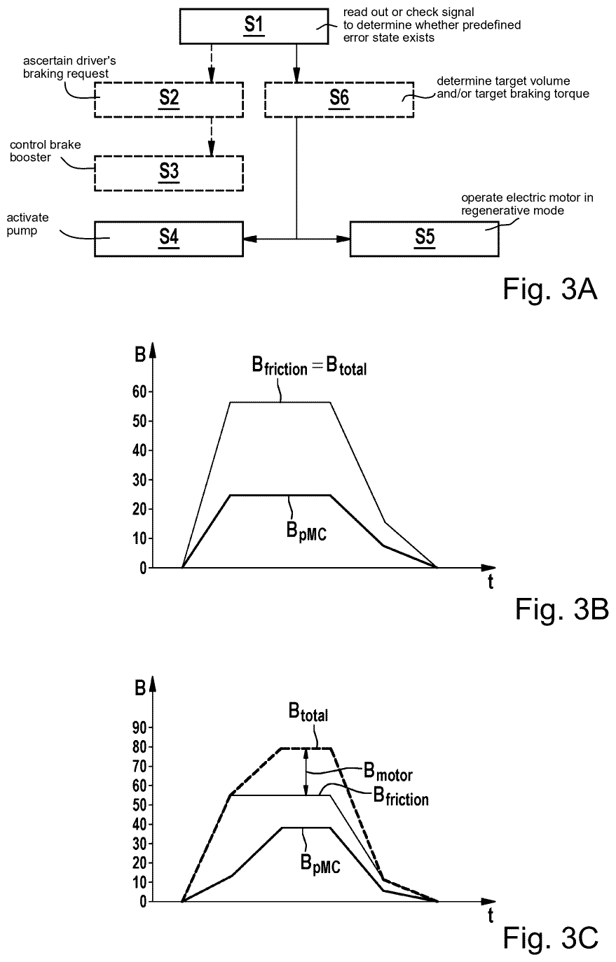

FIG. 3A to 3C show a flowchart and coordinate systems for explaining an embodiment of the method for operating a braking system of a vehicle, which braking system is equipped with a brake-actuation hydraulic unit and an ESC hydraulic unit.

The feasibility of the method described below is not limited to any particular vehicle type/motor vehicle type of the vehicle/motor vehicle equipped with the braking system or to a specific total number of wheels of the vehicle/motor vehicle.

In method step S1, at least one signal is read out or checked to determine whether at least one predefined error state exists at the brake-actuation hydraulic unit. Examples of the at least one signal and the at least one predefined error state are already mentioned above.

If it is determined based on the at least one signal that the at least one predefined error state is not present in the brake-actuation hydraulic unit, the braking system is operated according to a normal operating mode represented by the coordinate system of FIG. 3B. The abscissa of the coordinate system of FIG. 3B is the time axis t, while the ordinate of the coordinate system of FIG. 3B represents braking torques B.

In the normal operating mode shown schematically in FIG. 3B, the driver of the vehicle requests braking of the vehicle by actuating a brake-actuation element of the braking system. The driver's braking request is ascertained in method step S2 on the basis of at least one sensor signal from at least one brake-actuation element sensor of the braking system and/or at least one pressure sensor of the ESC hydraulic unit and/or the brake-actuation hydraulic unit. In particular, if a brake booster of the brake-actuation hydraulic unit is a motorized piston-cylinder device integrated into the hydraulic system of the brake-actuation hydraulic unit 30, a master brake cylinder pressure present in a master brake cylinder of the brake-actuation hydraulic unit can be ascertained/estimated in order to ascertain the driver's braking request.

In the embodiment of the method described here, the motorized piston-cylinder device used as a brake booster has little or no influence on the master brake cylinder pressure. The master brake cylinder pressure is therefore (almost) exclusively controlled by the driver. The graph B_{pMC} shows an “exclusively driver-induced” braking torque B_{pMC} of the wheel brake cylinders of the braking system, which would be exerted on the vehicle if the master brake cylinder pressure prevailed in all wheel brake cylinders. However, it can be seen from the coordinate system of FIG. 3B that in the normal operating mode the brake booster is controlled in method step S3 in such a way that the wheel brake cylinders of the braking system exert a significantly increased frictional braking torque B_{friction} on the wheels of the vehicle due to the volume additionally displaced into the wheel brake cylinders by means of the operation of the brake booster. The friction braking torque B_{friction} can in particular correspond to a product of the “exclusively driver-induced” braking torque B_{pMC} with an amplification factor greater than one. The vehicle is then braked with a total braking torque Bₜₒₜₐₗ which (substantially) corresponds to the friction braking torque B_{friction} of the wheel brake cylinders.

The abscissa and ordinate of the coordinate system of FIG. 3C also represent the time axis t and braking torques B. The coordinate system of FIG. 3C shows what happens when, in method step S1, it is determined on the basis of the at least one signal that the single error state or one of the predefined error states exists at the brake-actuation hydraulic unit. If necessary, at least one of method steps S4 and S5 is then performed:

For example, as method step S4, at least one pump of the ESC hydraulic unit can be activated in order to draw in a firmly predefined or specified volume of brake fluid from a brake fluid reservoir of the braking system. By drawing in the additional brake fluid volume, an additional brake pressure build-up is achieved in the wheel brake cylinders, causing the friction braking torque B_{friction} to increase.

In the embodiment described here, however, if the existence of the single error state or one of the predefined error states at the brake-actuation hydraulic unit is detected in method step S1, method step S5 is performed. As method step S5, at least one electric motor of the vehicle which can be operated in a regenerative mode is controlled in order to effect a firmly predefined or specified motor braking torque Bₘₒₜₒᵣ not equal to zero at at least one wheel of the vehicle and/or at least one axle of the vehicle. By performing method step S5, the total braking torque Bₜₒₜₐₗ is thus not only achieved purely hydraulically, but also by means of the at least one electric motor used as a generator. This results in the volume in the master brake cylinder being sufficient for a longer period of time when high deceleration values are achieved. Furthermore, method step S5 can be performed without negative effects on the driver, such as noises or movements of the brake-actuation element/brake pedal.

Preferably, method step S6 is performed between the detection of the existence of the single error state or one of the predefined error states at the brake-actuation hydraulic unit and at least one of method steps S4 or S5. In method step S6, a target volume of the brake fluid volume to be drawn in by means of method step S4 and/or a target braking torque of the motor braking torque Bₘₒₜₒᵣ to be exerted on the at least one wheel and/or on the at least one axle can be determined in light of the at least one sensor signal of the at least one brake-actuation element sensor of the braking system and/or the at least one pressure sensor of the ESC hydraulic unit and/or the brake-actuation hydraulic unit. As can be seen from the coordinate system of FIG. 3C, the total braking torque Bₜₒₜₐₗ exerted as the sum of the friction braking torque B_{friction} of the wheel brake cylinders and the motor braking torque Bₘₒₜₒᵣ of the at least one electric motor can also correspond to the product of the “exclusively driver-induced” braking torque B_{pMC} with the amplification factor greater than one.

The at least one electric motor used as a generator can optionally be used to perform method step S5 as soon as the existence of the single error state or one of the predefined error states is detected in the brake-actuation hydraulic unit and thus even at the start of braking. Preferably, however, performing method step S5 is delayed until no more hydraulic volume can be drawn in from the brake fluid reservoir of the braking system by performing method step S4. In this way, linear amplification is possible without cyclically checking the driver's request.

1-12. (canceled)

13. A control device or a braking system belonging to a vehicle and equipped with a brake-actuation hydraulic unit and an electronic stability control (ESC) hydraulic unit, the control device configured to:
read out or check, based on at least one signal provided to the control device, whether at least one predefined error state exists at the brake-actuation hydraulic unit, which is mounted on the ESC hydraulic unit; and
based on the determining, in light of the at least one signal, that a single predefined error state or at least one of the predefined error states exists at the brake-actuation hydraulic unit:
activate at least one pump of the ESC hydraulic unit to draw in a brake fluid volume, which is firmly predefined or is specified by the control device, from a brake fluid reservoir of the braking system, and/or
control at least one electric motor of the vehicle which can be operated in a regenerative mode in order to effect a motor braking torque, which is firmly predefined or specified by the control device and is not equal to zero, at at least one wheel of the vehicle and/or at least one axle of the vehicle.

14. The control device according to claim 13, wherein, if the control device determines, in light of the at least one signal, that the single predefined error state or at least one of the predefined error states exists at the brake-actuation hydraulic unit, the control device is configured to determine a target volume of the brake fluid volume to be drawn in from the brake fluid reservoir in light of at least one sensor signal of at least one brake-actuation element sensor of the braking system and/or at least one pressure sensor of the ESC hydraulic unit and/or the brake-actuation hydraulic unit, and then activate the at least one pump of the ESC hydraulic unit to draw in the brake fluid volume corresponding to the determined target volume from the brake fluid reservoir.

15. The control device according to claim 14, wherein, if the control device determines, in light of the at least one signal, that the single predefined error state or at least one of the predefined error states exists at the brake-actuation hydraulic unit, the control device is configured to determine a target braking torque of the motor braking torque to be exerted at the at least one wheel and/or at the at least one axle in light of the at least one sensor signal of the at least one brake-actuation element sensor of the braking system and/or the at least one pressure sensor of the ESC hydraulic unit and/or the brake-actuation hydraulic unit, and then actuate the at least one electric motor to effect the motor braking torque corresponding to the determined target braking torque at the at least one wheel and/or the at least one axle.

16. The control device according to claim 13, wherein the control device is configured to detect: (i) a functional impairment and/or a failure of a brake booster of the brake-actuation hydraulic unit, and/or (ii) a functional impairment and/or a failure of at least one valve of the brake-actuation hydraulic unit, and/or (iii) a functional impairment and/or a failure of at least one sensor apparatus of the brake-actuation hydraulic unit, and/or (iv) a functional impairment and/or a failure of a first power supply of at least the brake booster of the brake-actuation hydraulic unit and/or the at least one valve of the brake-actuation hydraulic unit and/or the at least one sensor apparatus of the brake-actuation hydraulic unit, as the at least one predefined error state based on the at least one signal.

17. The control device according to claim 13, wherein the control device, at least as long as the at least one predefined error state does not exist at the brake-actuation hydraulic unit, is configured to detect a wheel lock effected using at least one of the wheel brake cylinders based on at least one measurement signal from at least one speed sensor of at least one wheel of the vehicle, and optionally switch at least one valve of the ESC hydraulic unit to its open state such that brake fluid can be drained from the at least one blocking wheel brake cylinder via the at least one open valve.

18. An electronic stability control (ESC) hydraulic unit for a braking system belonging to a vehicle and additionally equipped with a brake-actuation hydraulic unit, the ESC hydraulic unit comprising:
a control device configured to:
read out or check, based on at least one signal provided to the control device, whether at least one predefined error state exists at the brake-actuation hydraulic unit, which is mounted on the ESC hydraulic unit; and
based on the determining, in light of the at least one signal, that a single predefined error state or at least one of the predefined error states exists at the brake-actuation hydraulic unit:
activate at least one pump of the ESC hydraulic unit to draw in a brake fluid volume, which is firmly predefined or specified by the control device, from a brake fluid reservoir of the braking system, and/or
control at least one electric motor of the vehicle which can be operated in a regenerative mode in order to effect a motor braking torque, which is firmly predefined or is specified by the control device and is not equal to zero, at at least one wheel of the vehicle and/or at least one axle of the vehicle.

19. The ESC hydraulic unit according to claim 18, wherein the ESC hydraulic unit further comprises:
at least one high-pressure switching valve, via which a corresponding intake side of the at least one pump of the ESC hydraulic unit is hydraulically connectable or connected to the brake fluid reservoir of the braking system;
wherein the control device is additionally configured to switch the at least one high-pressure switching valve to its open state while operation of the at least one pump is activated in order to draw in the brake fluid volume from the brake fluid reservoir.

20. A braking system for a vehicle, comprising:
an electronic stability control (ESC) hydraulic unit including
a control device configured to:
read out or check, based on at least one signal provided to the control device, whether at least one predefined error state exists at the brake-actuation hydraulic unit, which is mounted on the ESC hydraulic unit; and
based on the determining, in light of the at least one signal, that a single predefined error state or at least one of the predefined error states exists at the brake-actuation hydraulic unit:
activate at least one pump of the ESC hydraulic unit to draw in a brake fluid volume, which is firmly predefined or specified by the control device, from a brake fluid reservoir of the braking system, and/or
control at least one electric motor of the vehicle which can be operated in a regenerative mode in order to effect a motor braking torque, which is firmly predefined or is specified by the control device and is not equal to zero, at at least one wheel of the vehicle and/or at least one axle of the vehicle;
the brake-actuation hydraulic unit; and
wheel brake cylinders, which are mounted on the ESC hydraulic unit.

21. The braking system according to claim 20, wherein the brake-actuation hydraulic unit is connectable or connected to a first power supply and the ESC hydraulic unit is connectable or connected to a second power supply.

22. The braking system according to claim 20, wherein the brake-actuation hydraulic unit has control electronics which are configured to control at least a brake booster of the brake-actuation hydraulic unit in light of: (i) at least a brake-actuation element sensor of the braking system and/or (ii) at least one pressure sensor of the brake-actuation hydraulic unit.

23. The braking system according to claim 22, wherein the brake booster of the brake-actuation hydraulic unit is a brake booster arranged upstream of a master brake cylinder of the brake-actuation hydraulic unit or a motorized piston-cylinder device integrated into the hydraulic system of the brake-actuation hydraulic unit.

24. A method for operating a braking system belonging to a vehicle and equipped with a brake-actuation hydraulic unit and an electronic stability control (ESC) hydraulic unit, the method comprising the following steps:
reading out or checking, based on at least one signal, whether at least one predefined error state exists at the brake-actuation hydraulic unit, which is mounted on the ESC hydraulic unit;
performing, when, in light of the at least one signal, it is determined that the at least one predefined error state exists at the brake-actuation hydraulic unit, at least one of the following steps:
activating at least one pump of the ESC hydraulic unit to draw in a firmly predefined or specified brake fluid volume from a brake fluid reservoir of the braking system; and/or
controlling at least one electric motor of the vehicle which can be operated in a regenerative mode to effect a firmly predefined or specified motor braking torque not equal to zero at at least one wheel of the vehicle and/or at least one axle of the vehicle.
